(19) United States
(12) Patent Application Publication
(10) Pub. No.: US 2023/0382349 A1
(43) Pub. Date: Nov. 30, 2023

(54) VEHICLE AND METHOD OF CONTROLLING THE SAME

(71) Applicants: Hyundai Motor Company, Seoul (KR); Kia Corporation, Seoul (KR)

(72) Inventor: Jeonghun Ham, Goyang (KR)

(21) Appl. No.: 18/078,201

(22) Filed: Dec. 9, 2022

(30) Foreign Application Priority Data
May 25, 2022 (KR) 10-2022-0064106

(51) Int. Cl. B60R 25/25; G06V 40/20; G06V 40/16; G10L 17/22; H04R 3/00; H04R 1/08; G10L 17/10; B60R 25/30

(52) U.S. Cl. CPC B60R 25/25; G06V 40/20; G06V 40/172; G10L 17/22; H04R 3/00; H04R 1/08; G10L 17/10; G06V 40/171; B60R 25/257; B60R 25/305; H04R 2499/13

(57) ABSTRACT

Systems and methods of controlling a vehicle may include performing user authentication through facial recognition of a user who may be in a state of not getting into the vehicle, receiving a voice command generated by an utterance of the user who may be in the state of not getting into the vehicle, performing voice recognition of the received voice command, and performing a vehicle control corresponding to the voice command as the result of the voice recognition.

### CROSS-REFERENCE TO RELATED APPLICATION

This application claims under 35 U.S.C. § 119(a) the benefit of Korean Patent Application No. 10-2022-0064106, filed on May 25, 2022 in the Korean Intellectual Property Office, the disclosure of which is incorporated herein by reference.

### BACKGROUND

### 1. Field

Embodiments of the present disclosure relate to a vehicle, and more particularly, to user authentication and control of the vehicle.

### 2. Description of the Related Art

Methods of unlocking a door of a vehicle and performing necessary operations on the vehicle basically include unlocking the door of the vehicle using a vehicle key and operating a target through a button, a touch screen, or the like by being seated on a driver's seat or the like.

Recently, instead of unlocking the door using the vehicle key, a technique of automatically unlocking the door through user authentication using a facial recognition technique may be used.

However, even when the user authentication through facial recognition replaces the existing key use, a user needs a process of operating a necessary button, touch screen, or the like after getting into the vehicle in order to operate a specific function of the vehicle.

### SUMMARY

Therefore, it is an embodiment of the present disclosure to allow a user to perform a desired operation for a vehicle from the outside of the vehicle through a voice command or a gesture even in a state in which the user does not get into the vehicle when user authentication is completed through facial recognition.

Additional embodiments of the disclosure will be set forth in part in the description which follows and, in part, will be obvious from the description, or may be learned by practice of the disclosure.

In accordance with one embodiment of the present disclosure, a method of controlling a vehicle according to the present disclosure includes performing user authentication through facial recognition of a user who may be in a state of not getting into the vehicle, receiving a voice command generated by an utterance of the user who may be in the state of not getting into the vehicle, performing voice recognition of the received voice command, and performing a vehicle control corresponding to the voice command as the result of the voice recognition.

The method may further include automatically activating a microphone to receive the voice command when the user authentication through the facial recognition may be completed.

The method may further include automatically activating a microphone to receive the voice command when the user authentication through the facial recognition may be completed and a face of the user maintains a facial recognition position within an image for the facial recognition.

The method may further include automatically activating a microphone to receive the voice command when the user authentication through the facial recognition may be completed and the user makes a predetermined specific gesture in an image captured for the facial recognition.

The voice recognition may be performed based on at least one of deep learning and artificial intelligence.

The method may further include automatically activating a microphone to receive the voice command by determining that the user has not gotten into the vehicle when the user authentication through the facial recognition may be completed and a door of the vehicle may not be closed after opening.

The method may further include automatically activating a microphone to receive the voice command by detecting an occupant in the vehicle and determining that the user has not gotten into the vehicle when no occupant may be detected in the vehicle when the user authentication through the facial recognition may be completed.

The method may further include confirming whether the recognized voice matches a pre-registered user's voice when the voice recognition may be completed, wherein the vehicle control corresponding to the voice command may be performed by acknowledging a validation of the voice command when the recognized voice matches the pre-registered user's voice.

The method may further include confirming whether a shape of a mouth corresponding to the recognized voice command matches a shape of an actual mouth upon the utterance of the user when the voice recognition may be completed, wherein the vehicle control corresponding to the voice command may be performed by acknowledging the validation of the voice command when the shape of the mount of the recognized voice command matches the shape of the actual mouth upon the utterance of the user.

The method may further include confirming whether a volume of the recognized voice may be higher than a preset reference volume when the voice recognition may be completed, wherein the vehicle control corresponding to the voice command may be performed by acknowledging the validation of the voice command when the volume of the recognized voice may be higher than the preset reference volume.

The method may further include maintaining an active state of the microphone for a preset time when the microphone provided to receive the voice command may be activated.

The method may further include displaying the active state of the microphone through a display while the microphone may be activated.

In accordance with another embodiment of the present disclosure, a vehicle includes a facial recognition module provided in the vehicle configured to perform facial recognition, gesture recognition, and voice recognition of a user who may be in a state of not getting into the vehicle, wherein the facial recognition module includes a camera configured to capture a face and gesture of the user who may be in the state of not getting into the vehicle, a microphone configured to receive a voice generated by an utterance of the user who may be in the state of not getting into the vehicle, and a controller configured to perform user authentication through the facial recognition of the user who may be in the state of not getting into the vehicle, receive a voice command generated by the utterance of the user who may be in the state of not getting into the vehicle, perform the voice recognition of the received voice command, and perform a vehicle control corresponding to the voice command as the result of the voice recognition.

The controller may be configured to automatically activate the microphone to receive the voice command when the user authentication through the facial recognition may be completed.

The controller may be configured to maintain an active state of the microphone for a preset time when the microphone may be activated.

The facial recognition module may further include a display configured to display the active state of the microphone while the microphone may be activated.

In accordance with still another embodiment of the present disclosure, a method of controlling a vehicle includes performing user authentication through facial recognition of a user who may be in a state of not getting into the vehicle, maintaining an active state of a microphone for a preset time by automatically activating the microphone to receive a voice command when the user authentication through the facial recognition may be completed, displaying the active state of the microphone through a display while the microphone may be activated, receiving a received voice command from the microphone generated from the voice command or an utterance of the user who may be in the state of not getting into the vehicle, performing voice recognition of the received voice command, and performing a vehicle control corresponding to the received voice command as the result of the voice recognition.

The method may further include automatically activating the microphone to receive the voice command when the user authentication through the facial recognition is completed and the user makes a predetermined specific gesture in an image captured for the facial recognition.

The method may further include automatically activating the microphone to receive the voice command by determining that the user has not gotten into the vehicle when the user authentication through the facial recognition is completed and a door of the vehicle is not closed after opening.

The method may further include automatically activating the microphone to receive the voice command by detecting an occupant in the vehicle and determining that the user has not gotten into the vehicle when no occupant is detected in the vehicle when the user authentication through the facial recognition is completed.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 is a view showing a vehicle according to one embodiment of the present disclosure;

FIG. 2 is a view showing facial recognition of the vehicle according to the embodiment of the present disclosure;

FIG. 3 is a view showing a facial recognition module of the vehicle according to the embodiment of the present disclosure;

FIG. 4 is a view showing a control system of the vehicle according to the embodiment of the present disclosure;

FIG. 5 is a view showing another control system of the vehicle according to the embodiment of the present disclosure;

FIG. 6 is a view showing a method of controlling a vehicle according to a first embodiment of the present disclosure;

FIG. 7 is a view showing a method of controlling a vehicle according to a second embodiment of the present disclosure;

FIG. 8 is a view showing a method of controlling a vehicle according to a third embodiment of the present disclosure;

FIG. 9 is a view showing a method of controlling a vehicle according to a fourth embodiment of the present disclosure;

FIG. 10 is a view showing a method of controlling a vehicle according to a fifth embodiment of the present disclosure;

FIG. 11 is a view showing a method of controlling a vehicle according to a sixth embodiment of the present disclosure;

FIG. 12 is a view showing a method of controlling a vehicle according to a seventh embodiment of the present disclosure;

FIG. 13 is a view showing a method of controlling a vehicle according to an eighth embodiment of the present disclosure;

FIG. 14 is a view showing a method of controlling a vehicle according to a ninth embodiment of the present disclosure; and

FIG. 15 is a view showing a method of controlling a vehicle according to a tenth embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

The specification does not describe all elements of the embodiments, and general contents in the art to which the present disclosure pertains or overlapping contents among the embodiments will be omitted. Terms “unit, module, member, and block” used in the specification may be implemented in software and/or hardware, and according to the embodiments, a plurality of “units, modules, members, and blocks” may be implemented as one component or one “unit, module, member, and block” may also include a plurality of components.

Throughout the specification, when a certain portion may be described as being “connected” to another portion, it includes not only a case in which the certain portion may be directly connected to another portion but also a case in which it may be indirectly connected thereto, and the indirect connection includes a connection through a wireless communication network.

In addition, when a certain portion may be described as “including” a certain component, it means that other components may be further included, rather than excluding the other components unless otherwise stated.

Throughout the specification, when a certain member may be described as being positioned “on” another member, this includes not only a case in which one member comes into contact with another member but also a case in which other members may be present between the two members.

Terms such as first and second may be used to distinguish one component from another, and the components may not be limited by the above-described terms.

The singular expression includes the plural expression unless the context clearly dictates otherwise.

In each operation, identification signs may be used for convenience of description, and the identification signs do not describe the order of each operation, and each operation may be performed differently from the specified order unless the context clearly states the specific order.

Hereinafter, an operating principle and embodiments of the present disclosure will be described with reference to the accompanying drawings.

A user terminal may be implemented as a computer or a portable terminal which may access a vehicle through a network. Here, the computer may include, for example, a notebook PC, a desktop, a laptop, a tablet PC, a slate PC, and the like equipped with a web browser, and the portable terminal may be a wireless communication device with guaranteed portability and mobility and may include, for example, any type of handheld-based wireless communication devices, such as personal communication system (PCS), global system for mobile communications (GSM), personal digital cellular (PDC), personal handyphone system (PHS), personal digital assistant (PDA), international mobile telecommunication (IMT)-2000, code division multiple access (CDMA)-2000, W-CDMA, and wireless broadband Internet (WiBro) terminals, and a smart phone and wearable devices, such as watches, rings, bracelets, anklets, necklaces, glasses, contact lenses, and head-mounted devices (HMDs).

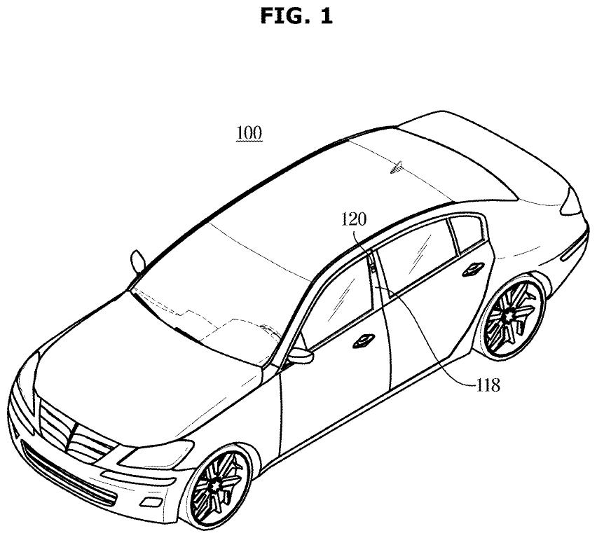

FIG. 1 is a view showing a vehicle according to one embodiment of the present disclosure.

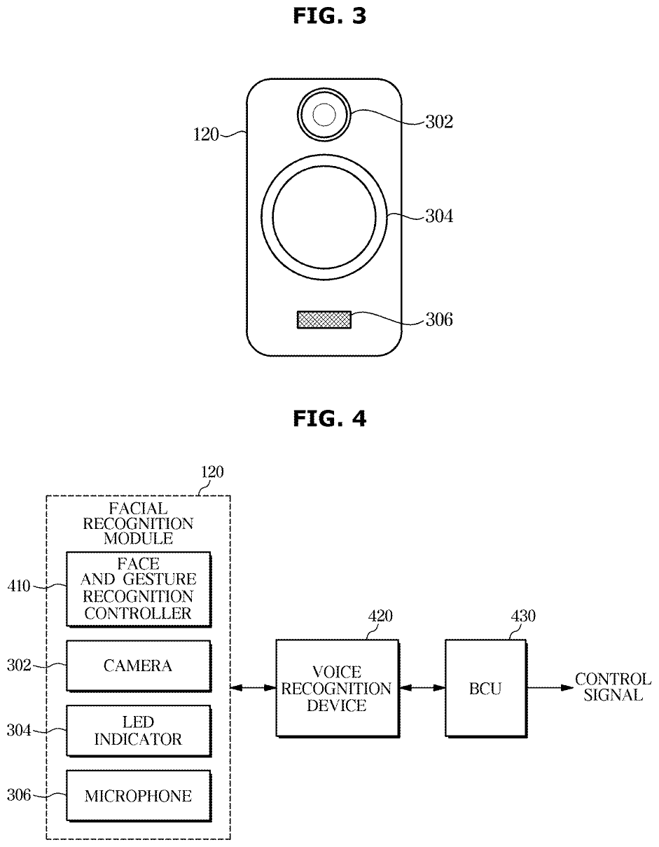

As shown in FIG. 1, a facial recognition module 120 may be provided in a driver's seat door frame 118 of a vehicle 100 according to an embodiment of the present disclosure. The facial recognition module 120 may be a device for capturing and registering a face of a user (subject) and recognizing and authenticating the face of the user (subject) who wants to get into the vehicle after registration. In addition, the user's gesture may also be registered or recognized using a capturing function of the facial recognition module 120. The facial recognition module 120 according to the embodiment of the present disclosure will be described in more detail with reference to FIG. 3 below.

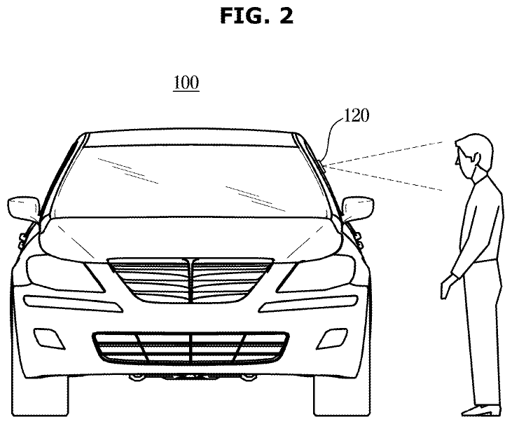

FIG. 2 is a view showing facial recognition of the vehicle according to the embodiment of the present disclosure.

As shown in FIG. 2, the user's face or a gesture made by the user may be captured using a camera 302 (see FIG. 3) of the facial recognition module 120. Since the camera 302 (see FIG. 3) of the facial recognition module 120 has an angle of view 202 having a certain angle, the face may be captured too large or too small depending on a position where the user stands to capture the face. Alternatively, the user's face may also be out of a capturing range.

FIG. 3 is a view showing the facial recognition module of the vehicle according to the embodiment of the present disclosure.

As shown in FIG. 3, the facial recognition module 120 of the vehicle 100 according to the embodiment of the present disclosure includes a camera 302, an LED indicator 304, and a microphone 306.

The camera 302 may be a device for capturing the user's face for registration and recognition of the user's face. The camera 302 may include a lens, an image sensor, a control circuit, and the like. The camera 302 may be an infrared camera.

The LED indicator 304 may be a display and may be a ring-shaped LED light source. The LED indicator 304 may be turned on in a plurality of different colors. For example, when the facial recognition and registration may be successful, the LED indicator 304 may be turned on in green so that the user may recognize that the facial recognition and registration have been successful. Alternatively, when the facial recognition and registration fail, the LED indicator 304 may be turned on in red so that the user may recognize that the facial recognition and registration have failed. Alternatively, some portions of the top/bottom/left/right of the ring-shaped LED indicator 304 may be turned on and the remaining portions may be turned off so that the user may recognize that the user's face may be biased to any one side of a captured region upon capturing. Alternatively, the ring-shaped LED indicator 304 may also display that a voice command may be currently being received through the microphone 306 by turning on a portion of the ring-shaped LED indicator 304 and rotating the turned-on portion along the ring shape. Alternatively, the LED indicator 304 may display that the voice command may be currently being received through the microphone 306 by turning on the LED indicator in a preset specific color for a preset time.

The microphone 306 may be a device for receiving the voice command generated by an utterance of the user positioned outside the vehicle 100. The user may generate the voice command from the outside of the vehicle 100 according to the embodiment of the present disclosure in a state of not getting into the vehicle so that a predetermined operation of the vehicle 100 may be performed.

FIG. 4 is a view showing a control system of the vehicle according to the embodiment of the present disclosure.

As shown in FIG. 4, the facial recognition module 120 further includes a face and gesture recognition controller 410 in addition to the camera 302, the LED indicator 304, and the microphone 306 already described with reference to FIGS. 1 to 3. The face and gesture recognition controller 410 may be a microprocessor that is configured to control overall operations for the user's face registration, facial recognition, gesture registration, and gesture recognition. The face and gesture recognition controller 410 may be configured to control the vehicle 100 by communicating with a body control unit (BCU) through a voice recognition device 420 through the cooperation with another electronic control unit (ECU) of the vehicle 100 as well as an operation of the facial recognition module 120 itself.

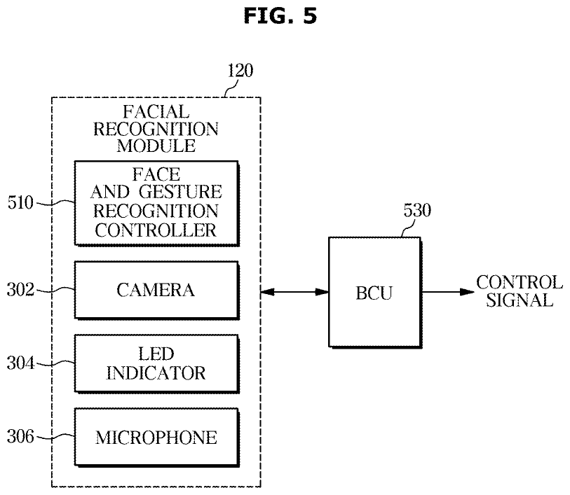

FIG. 5 is a view showing another control system of the vehicle according to the embodiment of the present disclosure.

As shown in FIG. 5, the facial recognition module 120 further includes a face and gesture recognition controller 510 in addition to the camera 302, the LED indicator 304, and the microphone 306 already described with reference to FIGS. 1 to 3. The face and gesture recognition controller 510 may be a microprocessor that is configured to control overall operations for the user's face registration, facial recognition, gesture registration, and gesture recognition. The face and gesture recognition controller 510 may be configured to control the vehicle 100 by communicating directly with the BCU through the cooperation with another ECU of the vehicle 100 as well as the operation of the facial recognition module 120 itself. In other words, the control system according to the embodiment of FIG. 5 controls the vehicle 100 by the direct communication between the facial recognition module 120 and a BCU 530, excluding the voice recognition function.

In the following description, the “face and gesture recognition controllers 410 and 510” will be simply referred to as “controllers 410 and 510.”

The controller 120 for facial recognition and gesture recognition may be implemented by a memory (not shown) configured to store data on an algorithm for controlling the operations of the components in the vehicle or a program for reproducing the algorithm and a processor (not shown) configured to perform the above-described operation using the data stored in the memory. In this case, the memory and the processor may be implemented as separate chips, respectively. Alternatively, the memory and the processor may also be implemented as a single chip. One or more memory and/or one or more processors may be used to accomplish the functions of the controller described herein.

A communicator may include one or more components configured to enable communication with an external device and include, for example, at least one of a short-range communication module, a wired communication module, and a wireless communication module.

The short-range communication module may include various short-range communication modules configured to transmit and receive signals using a wireless communication network in a short range, such as a Bluetooth module, an infrared communication module, a radio frequency identification (RFID) communication module, a wireless local access network (WLAN) communication module, an NFC communication module, and a Zigbee communication module.

The wired communication module may include not only various wired communication modules, such as a controller area network (CAN) communication module, a local area network (LAN) module, a wide area network (WAN) module, and a value added network (VAN) module, but also various cable communication modules, such as an universal serial bus (USB), a high definition multimedia interface (HDMI), a digital visual interface (DVI), a recommended standard232 (RS-232), power line communication, or a plain old telephone service (POTS).

In addition to the Wi-Fi module and the wireless broadband module, the wireless communication module may include a wireless communication module configured to support various wireless communication methods, such as global system for mobile communication (GSM), code division multiple access (CDMA), wideband code division multiple access (WCDMA), universal mobile telecommunications system (UMTS), time division multiple access (TDMA), and long term evolution (LTE).

The wireless communication module may include a wireless communication interface including an antenna and a transmitter configured to transmit a wireless signal. In addition, the wireless communication module may further include a signal conversion module configured to modulate a digital control signal output from a controller through a wireless communication interface into a wireless signal having an analog form according to the control of the controller.

The wireless communication module may include a wireless communication interface including an antenna and a receiver configured to receive the wireless signal. In addition, the wireless communication module may further include a signal conversion module configured to demodulate the wireless signal having the analog form received through the wireless communication interface into the digital control signal.

A storage and/or memory may be implemented as at least one of nonvolatile memory devices, such as a cache, a read only memory (ROM), a programmable ROM (PROM), an erasable programmable ROM (EPROM), an electrically erasable programmable ROM (EEPROM), and a flash memory, volatile memory devices, such as a random access memory (RAM), and storage media, such as a hard disk drive (HDD) and a CD-ROM, but the present disclosure may not be limited thereto. The storage may be a memory implemented as a separate chip from the processor described above in connection with the controller or may also be implemented as a single chip with the processor.

The display may be provided as a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel, an organic light emitting diode (OLED) panel, or the like, but the present disclosure may not be limited thereto.

An input device may include hardware devices, such as various buttons or switches, a pedal, a keyboard, a mouse, a track-ball, various levers, a handle, and a stick for user input.

In addition, the input device may also include a graphical user interface (GUI), such as a touch pad for user input, that is, a software device. The touch pad may be implemented as a touch screen panel (TSP) to form a layered structure with the display.

When the input device may be implemented as the TSP forming the layered structure with the touch pad, the display may also be used as the input device.

At least one component may be added or deleted depending on the performance of the components of the vehicle shown in FIG. 1. In addition, it will be readily understood by those skilled in the art that the mutual positions of the components may be changed depending on the performance or structure of the system.

Meanwhile, each component shown in FIGS. 4 and 5 refers to software and/or hardware components, such as a field programmable gate array (FPGA) and an application specific integrated circuit (ASIC).

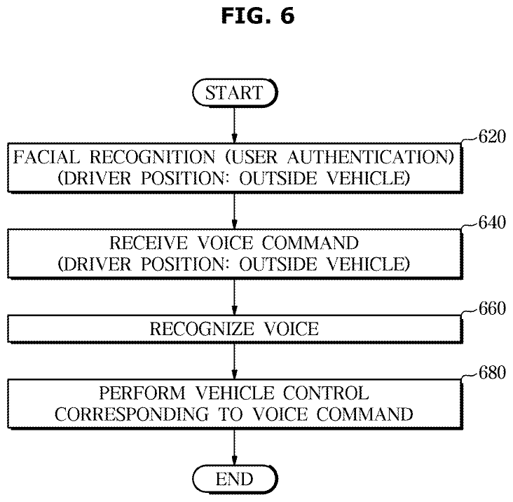

FIG. 6 is a view showing a method of controlling a vehicle according to a first embodiment of the present disclosure.

As shown in FIG. 6, the user of the vehicle 100 may perform user authentication through facial recognition from the outside of the vehicle 100 (in the state of not getting into the vehicle) using the facial recognition module 120 provided on the driver's seat door frame 118 (620). In other words, when the user brings his/her face close to the camera 302 of the facial recognition module 120 within a certain distance in a state of being positioned in front of a door of the driver's seat outside the vehicle 100, the camera 302 may be configured to capture the user's face. The controller 410 may be configured to perform the user authentication by extracting the user's facial feature by analyzing the image captured through the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication is completed, the controller 410 may be configured to activate the microphone 306 of the facial recognition module 120 and receive a voice command generated by an utterance of the user positioned outside the vehicle 100 (640). In other words, when a current user may be authenticated as the registered user through the facial recognition, the user may control the vehicle 100 through the voice command even in a state of being positioned outside the vehicle 100 without getting into the vehicle 100.

When the reception of the voice command by the user's utterance may be completed, the controller 410 may be configured to perform voice recognition and identify the content (substantial meaning) of the corresponding voice command (660). In other words, the controller 410 identifies whether the corresponding voice command is valid and identifies what kind of command it is when the corresponding voice command is valid.

When the validity and content of the voice command are identified, the controller 410 may be configured to perform control of the vehicle 100 corresponding to the voice command (680). For example, when the corresponding voice command may be “Open an engine room cover (hood),” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 may be opened.

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 may be relatively more convenient than performing an operation of opening the engine room cover in a state in which the user gets into the vehicle 100 after authentication and is seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

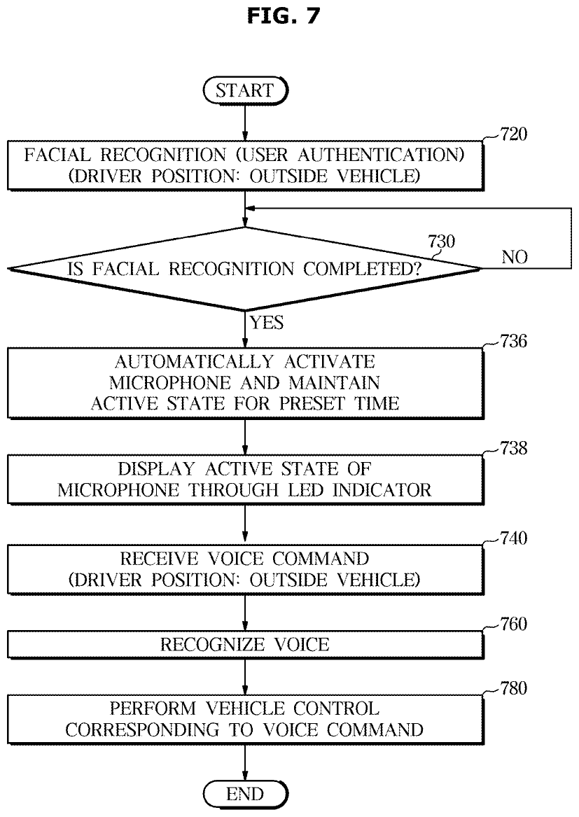

FIG. 7 is a view showing a method of controlling a vehicle according to a second embodiment of the present disclosure.

As shown in FIG. 7, the user of the vehicle 100 may perform user authentication through facial recognition from the outside of the vehicle 100 (in the state of not getting into the vehicle) using the facial recognition module 120 provided on the driver's seat door frame 118 (720). In other words, when the user brings his/her face close to the camera 302 of the facial recognition module 120 within a certain distance in a state of being positioned in front of a door of the driver's seat outside the vehicle 100, the user's face may be captured by the camera 302. The controller 410 performs the user authentication by extracting the user's facial feature by analyzing the image captured through the camera 302 and confirming whether the extracted facial feature matches pre-registered facial data by comparing the extracted facial feature and the pre-registered facial data. When a face having the same feature as the extracted facial feature may be already registered, the user having the corresponding face may be authenticated as a registered user, and the door of the vehicle 100 may be automatically unlocked.

When the user authentication through the facial recognition may be completed (“YES” in 730), the controller 410 may be configured to activate the microphone 306 of the facial recognition module 120 and then maintain the active state of the microphone 306 for a preset time (736). In addition, the controller 410 may be configured to control the LED indicator 304 of the facial recognition module 120 to display that the microphone 306 has been activated (738). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

While the microphone 306 is activated after the user authentication may be completed, the controller 410 may be configured to receive the voice command generated by an utterance of the user positioned outside the vehicle 100 (740). In other words, when a current user is authenticated as the registered user through the facial recognition, the user may control the vehicle 100 through the voice command even in a state of being positioned outside the vehicle 100 without getting into the vehicle 100.

When the reception of the voice command by the user's utterance may be completed, the controller 410 may be configured to perform voice recognition and identify the content (substantial meaning) of the corresponding voice command (760). In other words, the controller 410 identifies whether the corresponding voice command may be valid and identifies what kind of command it may be when the corresponding voice command may be valid.

When the validity and content of the voice command are identified, the controller 410 may be configured to control the vehicle 100 corresponding to the voice command (780). For example, when the corresponding voice command may be “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 may be opened.

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 may be relatively more convenient than performing an operation of opening the engine room cover in a state in which the user gets into the vehicle 100 after authentication and may be seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it may be restricted so that others other than the authenticated user may not input the voice command without permission by automatically activating the microphone 306 after the user authentication through the facial recognition and automatically deactivating the microphone 306 after maintaining the active state only for a preset time after activation.

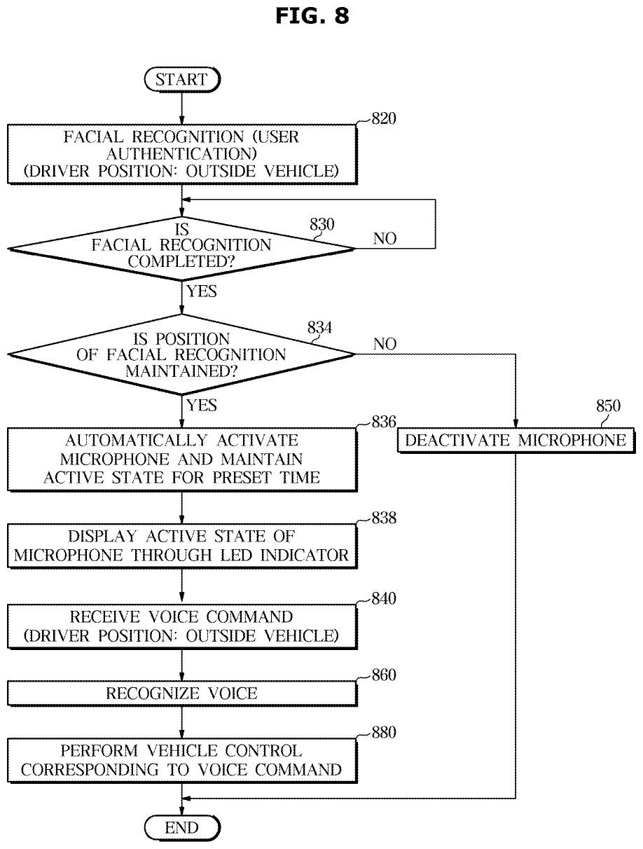

FIG. 8 is a view showing a method of controlling a vehicle according to a third embodiment of the present disclosure.

As shown in FIG. 8, the user of the vehicle 100 may perform user authentication through facial recognition from the outside of the vehicle 100 (in the state of not getting into the vehicle) using the facial recognition module 120 provided on the driver's seat door frame 118 (820). In other words, when the user brings his/her face close to the camera 302 of the facial recognition module 120 within a certain distance in a state of being positioned in front of a door of the driver's seat outside the vehicle 100, the user's face is captured by the camera 302. The controller 410 performs the user authentication by extracting the user's facial feature by analyzing the image captured through the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication through the facial recognition is completed (“Yes” in 830), the controller 410 confirms whether a position of the user's face captured through the camera 302 maintains a normal position within a facial recognition range for a preset time (834). The controller 410 determines that the user has the intention to generate the voice command only when the position of the user's face captured through the camera 302 maintains the normal position within the facial recognition range for the preset time (“Yes” in 834) and activates the microphone 306 of the facial recognition module 120 and then maintains the active state of the microphone 306 for the preset time (836). In addition, the controller 410 controls the LED indicator 304 of the facial recognition module 120 to display that the microphone 306 has been activated (838). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

Conversely, when the position of the user's face captured through the camera 302 deviates from the normal position within the facial recognition range before the preset time elapses (“No” in 834), the controller 410 determines that the user has no intention to generate the voice command and maintains an inactive state of the microphone 306 as it is (850).

While the microphone 306 is activated after the user authentication is completed, the controller 410 receives a voice command generated by an utterance of the user positioned outside the vehicle 100 (840). In other words, when a current user is authenticated as the registered user through the facial recognition, the user may control the vehicle 100 through the voice command even in a state of being positioned outside the vehicle 100 without getting into the vehicle 100.

When the reception of the voice command by the user's utterance is completed, the controller 410 performs voice recognition and identifies the content (substantial meaning) of the corresponding voice command (860). In other words, the controller 410 identifies whether the corresponding voice command is valid and identifies what kind of command it is when the corresponding voice command is valid.

When the validity and content of the voice command are determined, the controller 410 performs control of the vehicle 100 corresponding to the voice command (880). For example, when the corresponding voice command is “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 is opened.

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 may be relatively more convenient than performing an operation of opening the engine room cover in a state in which the user gets into the vehicle 100 after authentication and may be seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it may be restricted so that others other than the authenticated user may not input the voice command without permission by determining the user's intention to generate the voice command through the determination of whether the position of the user's face captured through the camera 302 maintains or deviates from the normal position within the facial recognition range for the preset time and determining whether to activate or deactivate the microphone 306 to limitedly activate the microphone 306 only when necessary.

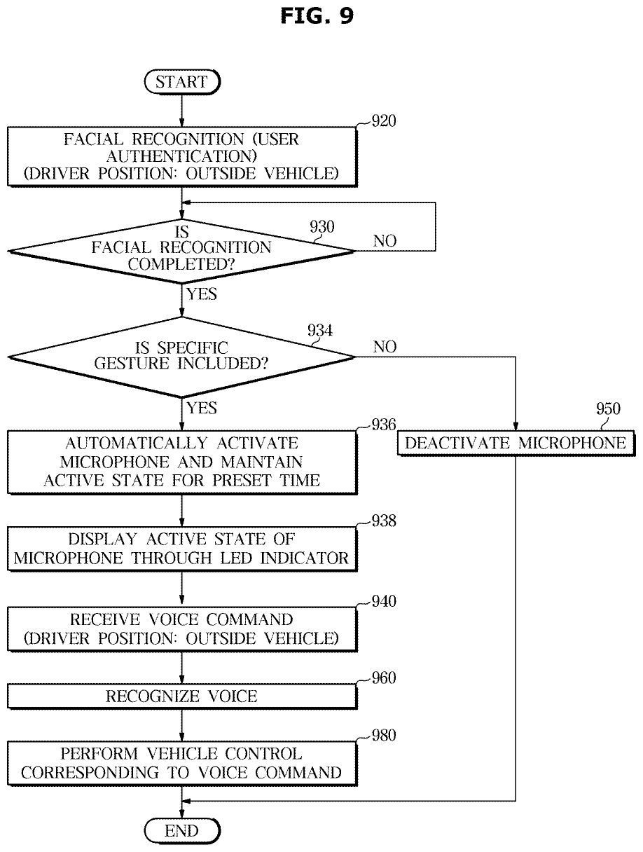

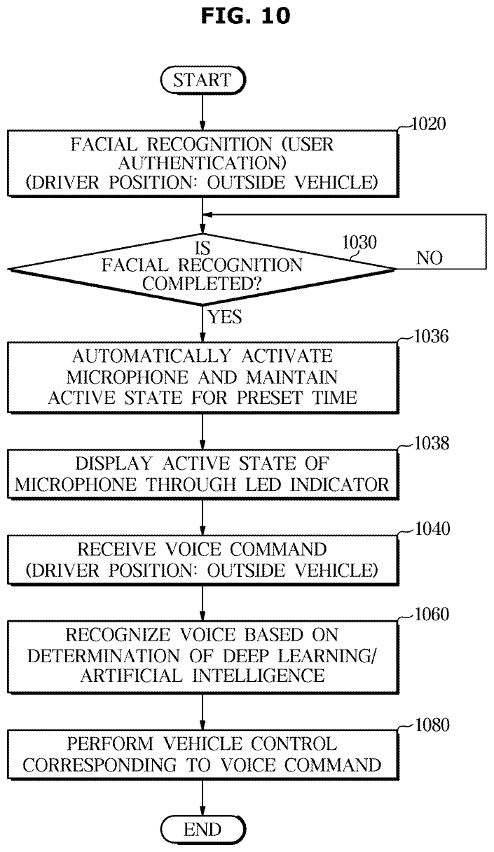

FIG. 9 is a view showing a method of controlling a vehicle according to a fourth embodiment of the present disclosure.

As shown in FIG. 9, the user of the vehicle 100 may perform the facial recognition from the outside of the vehicle 100 (in the state of not getting into the vehicle) using the facial recognition module 120 provided on the driver's seat door frame 118 (920). In other words, when the user brings his/her face close to the camera 302 of the facial recognition module 120 within a certain distance in a state of being positioned in front of a door of the driver's seat outside the vehicle 100, the user's face is captured by the camera 302. The controller 410 performs the user authentication by extracting the user's facial feature by analyzing the image captured by the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication through the facial recognition is completed (“Yes” in 930), the controller 410 confirms whether a preset specific gesture indicating the intention to input the voice command among user's actions captured through the camera 302 is included (934). For example, when a gesture of spreading two fingers is promised in advance as a gesture indicating the intention to input the voice command, the controller 410 confirms whether the user takes the gesture of spreading two fingers from the image captured through the camera 302. The controller 410 determines that the user has the intention to generate the voice command only when the user takes the preset specific gesture indicating the intention to input the voice command in the image captured through the camera 302 (“Yes” in 934) and activates the microphone 306 of the facial recognition module 120 and then maintains the active state of the microphone 306 for the preset time (936). In addition, the controller 410 controls the LED indicator 304 of the facial recognition module 120 to display that the microphone 306 has been activated (938). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

Conversely, when the user does not take the preset specific gesture indicating the intention to input the voice command in the image captured through the camera 302 (“No” in 934), the controller 410 determines that the user has no intention to generate the voice command and maintains the inactive state of the microphone 306 as it is (950).

While the microphone 306 is activated after the user authentication is completed, the controller 410 receives a voice command generated by an utterance of the user positioned outside the vehicle 100 (940). In other words, when a current user is authenticated as the registered user through the facial recognition, the user may control the vehicle 100 through the voice command even in a state of being positioned outside the vehicle 100 without getting into the vehicle 100.

When the reception of the voice command by the user's utterance is completed, the controller 410 performs voice recognition and identifies the content (substantial meaning) of the corresponding voice command (960). In other words, the controller 410 identifies whether the corresponding voice command is valid and what kind of command it is when the corresponding voice command is valid.

When the validity and content of the voice command are identified, the controller 410 performs control of the vehicle 100 corresponding to the voice command (980). For example, when the corresponding voice command is “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 is opened.

As described above, the user may perform both the user authentication through the facial recognition and the control of the vehicle 100 through the voice command even in the state of not getting into the vehicle 100. In other words, as in the embodiment of the present disclosure, it can be seen that controlling the vehicle through the user authentication and the voice command in the state in which the user does not get into the vehicle 100 is relatively more convenient than performing an operation of opening the engine room cover in a state in which the user gets into the vehicle 100 after authentication and is seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it may be restricted so that others other than the authenticated user may not input the voice command without permission by limitedly activating the microphone 306 only when the user takes the preset specific gesture indicating the intention to input the voice command in the image captured through the camera 302.

FIG. 10 is a view showing a method of controlling a vehicle according to a fifth embodiment of the present disclosure.

As shown in FIG. 10, the user of the vehicle 100 may perform user authentication through facial recognition from the outside of the vehicle 100 (in the state of not getting into the vehicle) using the facial recognition module 120 provided on the driver's seat door frame 118 (1020). In other words, when the user brings his/her face close to the camera 302 of the facial recognition module 120 within a certain distance in a state of being positioned in front of a door of the driver's seat outside the vehicle 100, the user's face is captured by the camera 302. The controller 410 performs the user authentication by extracting the user's facial feature by analyzing the image captured by the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication through the facial recognition is completed (“YES” in 1030), the controller 410 activates the microphone 306 of the facial recognition module 120 and then maintains the active state of the microphone 306 for a preset time (1036). In addition, the controller 410 controls the LED indicator 304 of the facial recognition module 120 to display that the microphone 306 has been activated (1038). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

While the microphone 306 is activated after the user authentication is completed, the controller 410 receives a voice command generated by an utterance of the user positioned outside the vehicle 100 (1040). In other words, when a current user is authenticated as the registered user through the facial recognition, the user may control the vehicle 100 through the voice command even in a state of being positioned outside the vehicle 100 without getting into the vehicle 100.

When the reception of the voice command by the user's utterance is completed, the controller 410 performs voice recognition using deep learning or artificial intelligence and identifies the content (substantial meaning) of the voice command (1060). In other words, the controller 410 identifies, using the deep learning or the artificial intelligence, whether the corresponding voice command is valid and what kind of command it is when the corresponding voice command is valid. For example, the controller 410 performs the control of the corresponding voice command only when a size, a pitch, and the like of an input voice signal (user's voice) match a size, a pitch, and the like of the previously input voice command by analyzing the size, the height, and the like of the input voice signal (user's voice) through the deep learning or artificial intelligence technique. Alternatively, the controller 410 may also perform only the control of the voice command having a history of use of a certain frequency or more by analyzing the frequency of use of commands normally used by the corresponding user through the deep learning or artificial intelligence technique. Alternatively, when the user utters the voice command, the controller 410 may also perform the corresponding control in conjunction with the voice command by analyzing a direction of a pupil, a direction of a face, or the like through the deep learning or the artificial intelligence technique. For example, the controller 410 may determine whether to perform the corresponding command based on whether the user's gaze or face is directed toward the engine room cover when an opening command of the engine room cover is generated.

When the validity and content of the voice command are identified, the controller 410 performs control of the vehicle 100 corresponding to the voice command (1080). For example, when the corresponding voice command is “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 is opened.

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 is relatively more convenient than performing an operation of opening the engine room cover in a state in which the user gets into the vehicle 100 after authentication and is seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it is possible to perform a more accurate voice command that further reflects the user's feature in the operation of recognizing the voice command by performing the voice recognition based on the determination of the deep learning or the artificial intelligence.

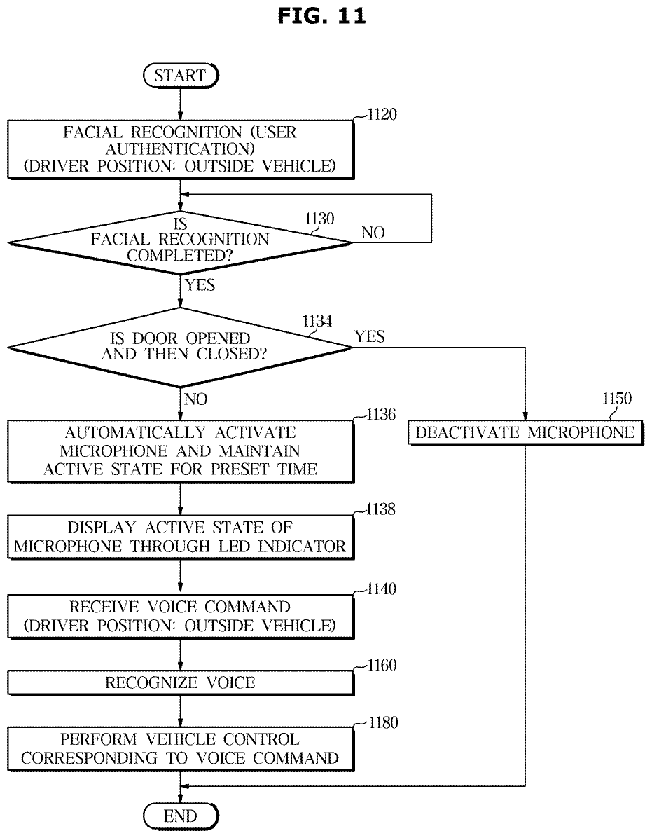

FIG. 11 is a view showing a method of controlling a vehicle according to a sixth embodiment of the present disclosure.

As shown in FIG. 11, the user of the vehicle 100 may perform user authentication through facial recognition from the outside of the vehicle 100 (in the state of not getting into the vehicle) using the facial recognition module 120 provided on the driver's seat door frame 118 (1120). In other words, when the user brings his/her face close to the camera 302 of the facial recognition module 120 within a certain distance in a state of being positioned in front of a door of the driver's seat outside the vehicle 100, the user's face is captured by the camera 302. The controller 410 performs the user authentication by extracting the user's facial feature by analyzing the image captured through the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication through the facial recognition is completed (“YES” in 1130), the controller 410 confirms whether the user gets into the vehicle 100 (1134). For example, when the door of the driver's seat of the vehicle 100 is opened and then closed, the controller 410 may determine that the user has gotten into the driver's seat of the vehicle 100. The controller 410 determines that the user has the intention to generate the voice command only when the user does not get into the vehicle 100 (“No” in 1134) and maintains the active state of the microphone 306 for the preset time after activating the microphone 306 of the facial recognition module 120 (1136). In addition, the controller 410 controls the LED indicator 304 of the facial recognition module 120 to display that the microphone 306 has been activated (1138). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

Conversely, when it is determined that the user has gotten into the vehicle 100 by the door of the vehicle opened and then closed (“YES” in 1134), the controller 410 determines that the user has no intention to generate the voice command and maintains the inactive state of the microphone 306 as it is (1150).

While the microphone 306 is activated after the user authentication is completed, the controller 410 receives a voice command generated by an utterance of the user positioned outside the vehicle 100 (1140). In other words, when a current user is authenticated as the registered user through the facial recognition, the user may control the vehicle 100 through the voice command even in a state of being positioned outside the vehicle 100 without getting into the vehicle 100.

When the reception of the voice command by the user's utterance is completed, the controller 410 performs voice recognition and identifies the content (substantial meaning) of the corresponding voice command (1160). In other words, the controller 410 identifies whether the corresponding voice command is valid and what kind of command it is when the corresponding voice command is valid.

When the validity and content of the voice command are identified, the controller 410 performs control of the vehicle 100 corresponding to the voice command (1180). For example, when the corresponding voice command is “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 is opened.

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 may be relatively more convenient than performing an operation of opening the engine room cover in a state in which the user gets into the vehicle 100 after authentication and may be seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it may be restricted so that others other than the authenticated user may not input the voice command without permission by limitedly activating the microphone 306 only when the user does not get into the vehicle 100.

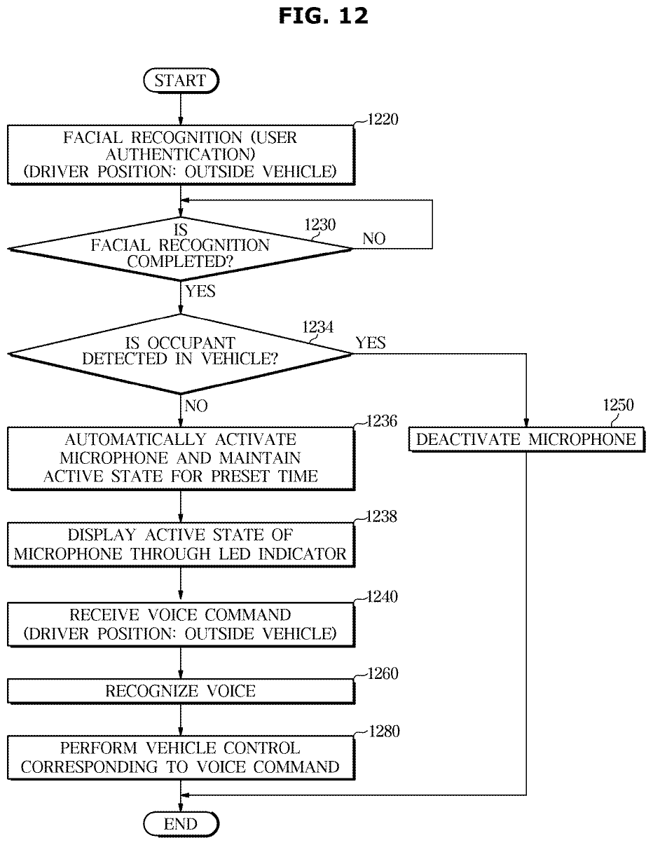

FIG. 12 is a view showing a method of controlling a vehicle according to a seventh embodiment of the present disclosure.

As shown in FIG. 12, the user of the vehicle 100 may perform user authentication through facial recognition from the outside of the vehicle 100 (in the state of not getting into the vehicle) using the facial recognition module 120 provided on the driver's seat door frame 118 (1220). In other words, when the user brings his/her face close to the camera 302 of the facial recognition module 120 within a certain distance in a state of being positioned in front of a door of the driver's seat outside the vehicle 100, the user's face is captured by the camera 302. The controller 410 performs the user authentication by extracting the user's facial feature by analyzing the image captured by the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication through the facial recognition is completed (“YES” in 1230), the controller 410 confirms whether an occupant is present in the vehicle 100 (1234). The presence of the occupant inside the vehicle 100 may be detected using an occupant detection system (ODS) or the like. Alternatively, whether the occupant is present inside the vehicle 100 may also be detected using a radar (not shown) or an indoor camera (not shown). The controller 410 determines that the user has the intention to generate the voice command only when the occupant is not present inside the vehicle 100 (“No” in 1234) and maintains the active state of the microphone 306 for the preset time after activating the microphone 306 of the facial recognition module 120 (1236). In addition, the controller 410 controls the LED indicator 304 of the facial recognition module 120 to display that the microphone 306 has been activated (1238). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

Conversely, when it is determined that the occupant is present inside the vehicle 100 (“YES” in 1234), the controller 410 determines that the user has no intention to generate the voice command and maintains the inactive state of the microphone 306 as it is (1250). This is because there is no need to control the vehicle 100 using an external voice recognition function in the state in which the user gets into the vehicle 100.

While the microphone 306 is activated after the user authentication is completed, the controller 410 receives a voice command generated by an utterance of the user positioned outside the vehicle 100 (1240). In other words, when a current user is authenticated as the registered user through the facial recognition, the user may control the vehicle 100 through the voice command even in a state of being positioned outside the vehicle 100 without getting into the vehicle 100.

When the reception of the voice command by the user's utterance is completed, the controller 410 performs voice recognition and identifies the content (substantial meaning) of the corresponding voice command (1260). In other words, the controller 410 identifies whether the corresponding voice command is valid and what kind of command it is when the corresponding voice command is valid.

When the validation and content of the voice command are identified, the controller 410 performs control of the vehicle 100 corresponding to the voice command (1280). For example, when the corresponding voice command is “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 is opened.

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 may be relatively more convenient than performing an operation of opening the engine room cover in a state in which the user gets into the vehicle 100 after authentication and may be seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it may be restricted so that others other than the authenticated user may not input the voice command without permission by limitedly activating the microphone 306 only when the user does not get into the vehicle 100 and deactivating the external voice recognition function in the state in which the user gets into the vehicle 100.

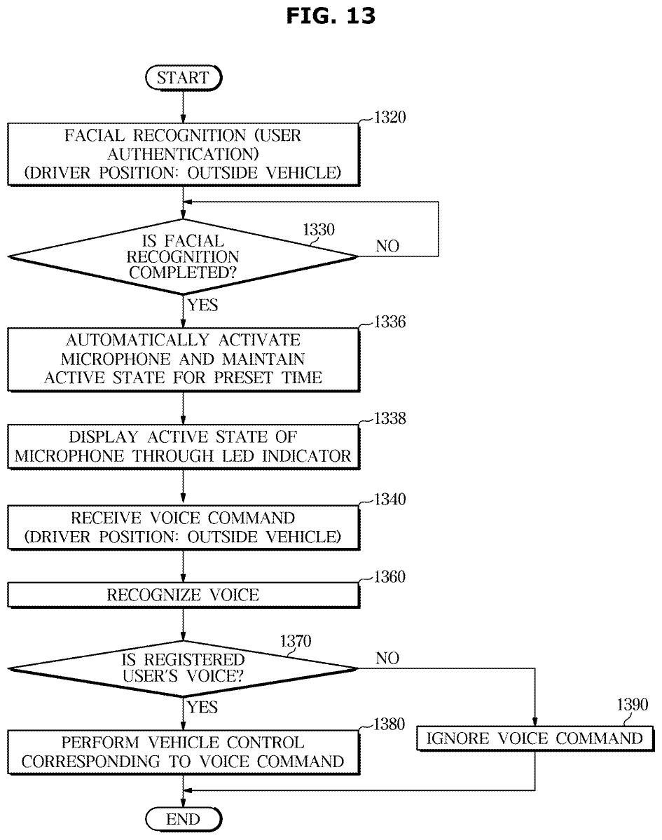

FIG. 13 is a view showing a method of controlling a vehicle according to an eighth embodiment of the present disclosure.

As shown in FIG. 13, the user of the vehicle 100 may perform user authentication through facial recognition from the outside of the vehicle 100 (in the state of not getting into the vehicle) using the facial recognition module 120 provided on the driver's seat door frame 118 (1320). In other words, when the user brings his/her face close to the camera 302 of the facial recognition module 120 within a certain distance in a state of being positioned in front of a door of the driver's seat outside the vehicle 100, the user's face is captured by the camera 302. The controller 410 performs the user authentication by extracting the user's facial feature by analyzing the image captured by the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication through the facial recognition is completed (“YES” in 1330), the controller 410 activates the microphone 306 of the facial recognition module 120 and then maintains the active state of the microphone 306 for a preset time (1336). In addition, the controller 410 controls the LED indicator 304 of the facial recognition module 120 to display that the microphone 306 has been activated (1338). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

While the microphone 306 is activated after the user authentication is completed, the controller 410 receives a voice command generated by an utterance of the user positioned outside the vehicle 100 (1340). In other words, when a current user is authenticated as the registered user through the facial recognition, the user may control the vehicle 100 through the voice command even in a state of being positioned outside the vehicle 100 without getting into the vehicle 100.

When the reception of the voice command by the user's utterance is completed, the controller 410 performs voice recognition and identifies the content (substantial meaning) of the corresponding voice command (1360). In other words, the controller 410 identifies whether the corresponding voice command is valid and what kind of command it is when the corresponding voice command is valid.

In addition, the controller 410 compares the voice recognition result with pre-registered voice data and confirms whether the current user's voice is the pre-registered user's voice (1370). In other words, it is possible to further improve the reliability of the user authentication by comparing (authenticating) the voice recognition even when the user authentication has already been performed through the facial recognition. The controller 410 compares a tone, a pitch, and the like of the current user's voice and those of the registered user's voice and authenticates that the current user is the same as the pre-registered user when they match.

When the validation and content of the voice command are completely identified and the authentication through the voice comparison is completed (“Yes” in 1370), the controller 410 performs control of the vehicle 100 corresponding to the corresponding voice command (1380). For example, when the corresponding voice command is “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 is opened.

Conversely, even when the validation and content of the voice command are completely identified, when the authentication through the voice comparison is not completed (“No” in 1370), the controller 410 ends the control of the vehicle 100 in a state of not performing the control of the vehicle 100 corresponding to the corresponding voice command (1390).

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 may be relatively more convenient than performing an operation of opening the engine room cover in a state in which the user gets into the vehicle 100 after authentication and may be seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it may be further restricted so that others other than the authenticated user may not input the voice command without permission by performing the user authentication through the voice comparison one more step after the user authentication through the facial recognition.

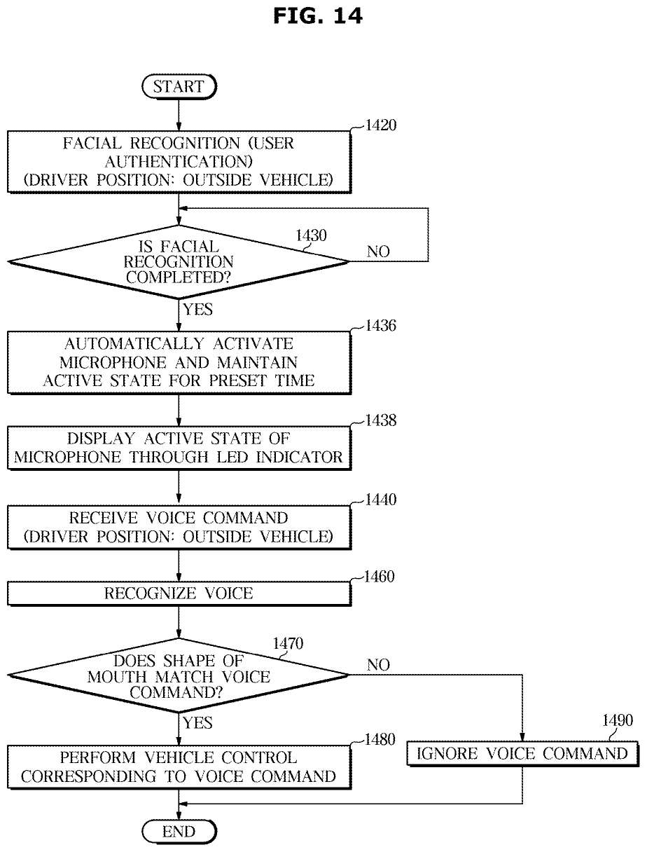

FIG. 14 is a view showing a method of controlling a vehicle according to a ninth embodiment of the present disclosure.

As shown in FIG. 14, the user of the vehicle 100 may perform user authentication through facial recognition from the outside of the vehicle 100 (in the state of not getting into the vehicle) using the facial recognition module 120 provided on the driver's seat door frame 118 (1420). In other words, when the user brings his/her face close to the camera 302 of the facial recognition module 120 within a certain distance in a state of being positioned in front of a door of the driver's seat outside the vehicle 100, the user's face is captured by the camera 302. The controller 410 performs the user authentication by extracting the user's facial feature by analyzing the image captured by the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication through the facial recognition is completed (“YES” in 1430), the controller 410 activates the microphone 306 of the facial recognition module 120 and then maintains the active state of the microphone 306 for a preset time (1436). In addition, the controller 410 controls the LED indicator 304 of the facial recognition module 120 to display that the microphone 306 has been activated (1438). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

While the microphone 306 is activated after the user authentication is completed, the controller 410 receives a voice command generated by an utterance of the user positioned outside the vehicle 100 (1440). In other words, when a current user is authenticated as the registered user through the facial recognition, the user may control the vehicle 100 through the voice command even in a state of being positioned outside the vehicle 100 without getting into the vehicle 100.

When the reception of the voice command by the user's utterance is completed, the controller 410 performs voice recognition and identifies the content (substantial meaning) of the corresponding voice command (1460). In other words, the controller 410 identifies whether the corresponding voice command is valid and what kind of command it is when the corresponding voice command is valid.

In addition, the controller 410 confirms whether the voice command whose content is identified matches a shape of a mouth when the user utters (1470). In other words, it is possible to further improve the reliability of the user authentication through the comparison (authentication) of the voice recognition even when the user authentication has already been performed through the facial recognition by detecting a change in the shape of the user's mouth through the image analysis of the user's face captured through the camera 302 and confirming whether the currently identified voice command is generated by the actual utterance of the user whose face has been currently authenticated.

When the validation and content of the voice command are completely identified and the authentication through the comparison of the shape of the mouth is completed (“YES” in 1470), the controller 410 performs control of the vehicle 100 corresponding to the corresponding voice command (1480). For example, when the corresponding voice command may be “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 is opened.

Conversely, even when the validation and content of the voice command are completely identified, when the authentication through the comparison of the shape of the mouth is not completed (“No” in 1470), the controller 410 ends the control of the vehicle 100 corresponding to the corresponding voice command (1490).

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 may be relatively more convenient than performing an operation of opening the engine room cover in a state in which the user gets into the vehicle 100 after authentication and may be seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it may be further restricted so that others other than the authenticated user may not input the voice command without permission by performing the user authentication through the comparison of the shape of the mouth one more step after the user authentication through the facial recognition.

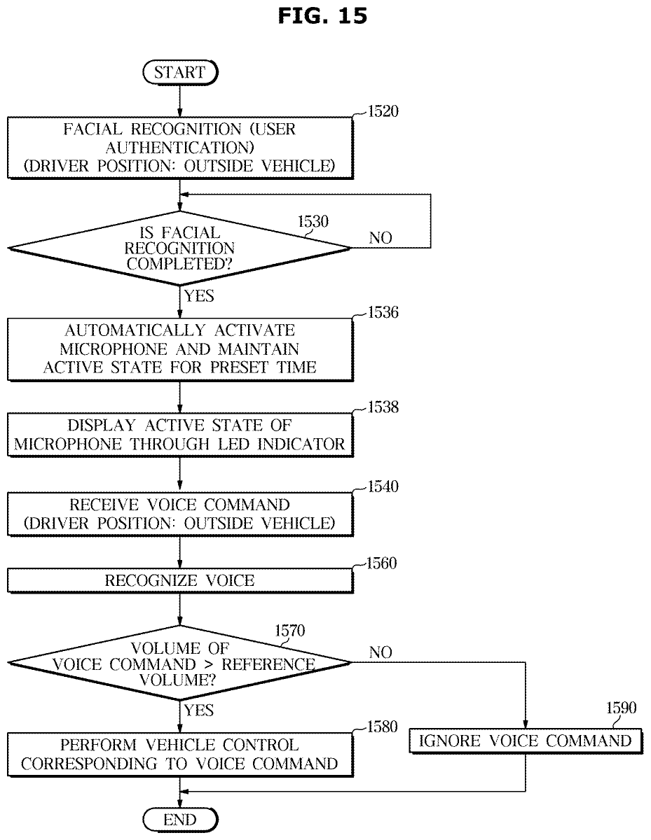

FIG. 15 is a view showing a method of controlling a vehicle according to a tenth embodiment of the present disclosure.

As shown in FIG. 15, the user of the vehicle 100 may perform user authentication through facial recognition from the outside of the vehicle 100 (in the state of not getting into the vehicle) using the facial recognition module 120 provided on the driver's seat door frame 118 (1520). In other words, when the user brings his/her face close to the camera 302 of the facial recognition module 120 within a certain distance in a state of being positioned in front of a door of the driver's seat outside the vehicle 100, the user's face is captured by the camera 302. The controller 410 performs the user authentication by extracting the user's facial feature by analyzing the image captured by the camera 302 and confirming whether the extracted facial feature matches pre-registered facial data by comparing the extracted facial feature and the pre-registered facial data. When a face having the same feature as the extracted facial feature is already registered, the user having the corresponding face may be authenticated as a registered user, and the door of the vehicle 100 may be automatically unlocked.

When the user authentication through the facial recognition is completed (“YES” in 1530), the controller 410 activates the microphone 306 of the facial recognition module 120 and then maintains the active state of the microphone 306 for a preset time (1536). In addition, the controller 410 controls the LED indicator 304 of the facial recognition module 120 to display that the microphone 306 has been activated (1538). For example, the controller 410 may control the ring-shaped LED indicator 304 to display that the voice command is currently being received through the microphone 306 by turning on a portion of the ring-shaped LED indicator 304 and rotating the turned-on portion along the ring shape. Alternatively, the LED indicator 304 may display that the voice command is currently being received through the microphone 306 by turning on the LED indicator 304 in the preset specific color for the preset time.

While the microphone 306 is activated after the user authentication is completed, the controller 410 receives a voice command generated by an utterance of the user positioned outside the vehicle 100 (1540). In other words, when the current user is authenticated as the registered user through the facial recognition, the user may control the vehicle 100 through the voice command even in a state of being positioned outside the vehicle 100 without getting into the vehicle 100.

When the reception of the voice command by the user's utterance is completed, the controller 410 performs voice recognition and identifies the content (substantial meaning) of the corresponding voice command (1560). In other words, the controller 410 identifies whether the corresponding voice command is valid and what kind of command it is when the corresponding voice command is valid.

In addition, the controller 410 compares a volume of a currently received voice signal with a pre-registered reference volume and confirms whether the volume of the current user's voice has a level higher than or equal to the reference volume (1570). In other words, it is possible to further improve the reliability of the user authentication through the volume comparison (authentication) even when the user authentication through the facial recognition has already been performed. The controller 410 compares the volume of the current user's voice with the reference volume, and authenticates the current user's voice as a valid voice command when they match. Therefore, it is possible to prevent others' voices around the vehicle 100 from being introduced into the microphone 306 and erroneously recognized as if they were voice commands.

When the validation and content of the voice command are completely identified and the authentication through the volume comparison is also completed (“YES” in 1570), the controller 410 performs control of the vehicle 100 corresponding to the corresponding voice command (1580). For example, when the corresponding voice command is “Open an engine room cover,” the voice recognition device 420 transmits a control command corresponding to the “Open an engine room cover” to the BCU 430 and the BCU 430 generates a control signal for opening the engine room cover of the vehicle 100 so that the engine room cover of the vehicle 100 is opened.

Conversely, even when the validation and content of the voice command are completely identified, when the authentication through the volume comparison is not completed (“No” in 1570), the controller 410 ends the control of the vehicle 100 corresponding to the corresponding voice command (1590).

As described above, the user may perform both the user authentication through the facial recognition and the control of the vehicle 100 through the voice command even in the state of not getting into the vehicle 100. In other words, as in the embodiment of the present disclosure, it may be seen that controlling the vehicle through the user authentication and the voice command in the state in which the user does not get into the vehicle 100 may be relatively more convenient than performing an operation of opening the engine room cover in a state in which the user gets into the vehicle 100 after authentication and may be seated on the driver's seat. Since the user does not need to get into the vehicle 100 when the user intends to only open the engine room cover without driving the vehicle 100, as in the embodiment of the present disclosure, the user may more conveniently control the vehicle 100 by performing the desired control of the vehicle through the user authentication and the voice command even in the state of not getting into the vehicle 100.

In addition, it may be further restricted so that others other than the authenticated user may not input the voice command without permission by performing the user authentication through the volume comparison one more step after the user authentication through the facial recognition.

Meanwhile, the disclosed embodiments may be implemented in the form of a recording medium configured to store instructions executable by a computer. The instructions may be stored in the form of program code and may perform the operations of the disclosed embodiments by generating a program module when executed by a processor. The recording medium may be implemented as a computer-readable recording medium.

The computer-readable recording medium includes all types of recording media in which the instructions readable by the computer may be stored. For example, there may be a read only memory (ROM), a random-access memory (RAM), a magnetic tape, a magnetic disk, a flash memory, an optical data storage device, and the like.

According to the embodiment of the present disclosure, it may be possible to perform a desired operation for a vehicle from the outside of the vehicle through a voice command or a gesture even in a state in which the user does not get into the vehicle when user authentication through facial recognition may be completed.

The disclosed embodiments have been described with reference to the accompanying drawings as described above. Those skilled in the art to which the present disclosure pertains will understand that the present disclosure may be carried out in other forms than the disclosed embodiments without changing the technical spirit or essential characteristics of the present disclosure. The disclosed embodiments may be illustrative and should not be construed as being restrictive.

What is claimed is:

1. A method of controlling a vehicle, the method comprising:
performing user authentication through facial recognition of a user who is in a state of not getting into the vehicle;
receiving a voice command generated by an utterance of the user who is in the state of not getting into the vehicle;
performing voice recognition of the received voice command; and
performing a vehicle control corresponding to the voice command as the result of the voice recognition.

2. The method of claim 1, further comprising automatically activating a microphone to receive the voice command when the user authentication through the facial recognition is completed.

3. The method of claim 1, further comprising automatically activating a microphone to receive the voice command when the user authentication through the facial recognition is completed and a face of the user maintains a facial recognition position within an image for the facial recognition.

4. The method of claim 1, further comprising automatically activating a microphone to receive the voice command when the user authentication through the facial recognition is completed and the user makes a predetermined specific gesture in an image captured for the facial recognition.

5. The method of claim 1, wherein the voice recognition is performed based on at least one of deep learning or artificial intelligence.

6. The method of claim 1, further comprising automatically activating a microphone to receive the voice command by determining that the user has not gotten into the vehicle when the user authentication through the facial recognition is completed and a door of the vehicle is not closed after opening.

7. The method of claim 1, further comprising automatically activating a microphone to receive the voice command by detecting an occupant in the vehicle and determining that the user has not gotten into the vehicle when no occupant is detected in the vehicle when the user authentication through the facial recognition is completed.

8. The method of claim 1, further comprising confirming whether the recognized voice matches a pre-registered user's voice when the voice recognition is completed,
wherein the vehicle control corresponding to the voice command is performed by acknowledging a validation of the voice command when the recognized voice matches the pre-registered user's voice.

9. The method of claim 1, further comprising confirming whether a shape of a mouth corresponding to the recognized voice command matches a shape of an actual mouth upon the utterance of the user when the voice recognition is completed,
wherein the vehicle control corresponding to the voice command is performed by acknowledging the validation of the voice command when the shape of the mount of the recognized voice command matches the shape of the actual mouth upon the utterance of the user.

10. The method of claim 1, further comprising confirming whether a volume of the recognized voice is higher than a preset reference volume when the voice recognition is completed,
wherein the vehicle control corresponding to the voice command is performed by acknowledging the validation of the voice command when the volume of the recognized voice is higher than the preset reference volume.

11. The method of claim 1, further comprising maintaining an active state of a microphone for a preset time when the microphone provided to receive the voice command is activated.

12. The method of claim 11, further comprising displaying the active state of the microphone through a display while the microphone is activated.

13. A vehicle comprising a facial recognition module provided in the vehicle to perform facial recognition, gesture recognition, and voice recognition of a user who is in a state of not getting into the vehicle,
wherein the facial recognition module includes:
a camera configured to capture a face and gesture of the user who is in the state of not getting into the vehicle;
a microphone configured to receive a voice generated by an utterance of the user who is in the state of not getting into the vehicle; and
a controller configured to perform user authentication through the facial recognition of an image from the camera of the user who is in the state of not getting into the vehicle, receive a voice command generated by the microphone from the utterance of the user who is in the state of not getting into the vehicle, perform the voice recognition of the received voice command, and perform a vehicle control corresponding to the voice command as the result of the voice recognition.

14. The vehicle of claim 13, wherein the controller is configured to automatically activate the microphone to receive the voice command when the user authentication through the facial recognition is completed.

15. The vehicle of claim 14, wherein the controller is configured to maintain an active state of the microphone for a preset time when the microphone is activated.

16. The vehicle of claim 15, wherein the facial recognition module further includes a display configured to display the active state of the microphone while the microphone is activated.

17. A method of controlling a vehicle, the method comprising:
performing user authentication through facial recognition of a user who is in a state of not getting into the vehicle;
maintaining an active state of a microphone for a preset time by automatically activating the microphone to receive a voice command when the user authentication through the facial recognition is completed;
displaying the active state of the microphone through a display while the microphone is activated;
receiving a received voice command from the microphone generated from the voice command of the user who is in the state of not getting into the vehicle;
performing voice recognition of the received voice command; and
performing a vehicle control corresponding to the received voice command as the result of the voice recognition.

18. The method of claim 17, further comprising automatically activating the microphone to receive the voice command when the user authentication through the facial recognition is completed and the user makes a predetermined specific gesture in an image captured for the facial recognition.

19. The method of claim 17, further comprising automatically activating the microphone to receive the voice command by determining that the user has not gotten into the vehicle when the user authentication through the facial recognition is completed and a door of the vehicle is not closed after opening.

20. The method of claim 17, further comprising automatically activating the microphone to receive the voice command by detecting an occupant in the vehicle and determining that the user has not gotten into the vehicle when no occupant is detected in the vehicle when the user authentication through the facial recognition is completed.
